(19) United States
(12) Patent Application Publication
(10) Pub. No.: US 2010/0302234 A1
(43) Pub. Date: Dec. 2, 2010

(54) METHOD OF ESTABLISHING DOF DATA OF 3D IMAGE AND SYSTEM THEREOF

(75) Inventors: MENG-CHAO KAO, Taipei City (TW); CHUN-CHUEH CHIU, Taoyuan County (TW); CHIEN-HUNG CHEN, Taipei County (TW); HSIANG-TAN LIN, Keelung City (TW)

Correspondence Address: WPAT, PC;INTELLECTUAL PROPERTY ATTORNEYS, 7225 BEVERLY ST., ANNANDALE, VA, 22003, US

(73) Assignee: CHUNGHWA PICTURE TUBES, LTD., Taoyuan (TW)

(21) Appl. No.: 12/472,852

(22) Filed: May 27, 2009

(51) Int. Cl. G06T 15/00

(52) U.S. Cl. 345/419

(57) ABSTRACT

A method and a system of establishing depth of field data of a 3D image, applicable to a 3D image including a first and a second visual image. The system includes a storage module, an offset calculator, and a comparator. An offset vector matrix includes data fields in the same number as that of pixels of a first visual image. An offset calculator divides a reference frame by taking an a^{th} first pixel of the first visual image as a center, and finds out a target frame having a minimum grayscale difference value with the reference frame from a second visual image, so as to calculate an offset vector value according to the minimum grayscale difference value. A comparator determines that the offset vector values of all the a^{th} first pixels are recorded in the offset vector matrix, so as to convert the offset vector matrix into a depth map.

### BACKGROUND OF THE INVENTION

1. Field of the Invention

The present invention relates to a method of establishing depth of field (DOF) data, and more particularly to a method of establishing DOF data and a system thereof, applicable to calculate offset values between two visual images in two different visual angles to obtain a depth map.

2. Related Art

In general, a three-dimensional (3D) image is formed by two sets of image data in different visual angles, in which one set of image data corresponds to a left-eye visual angle, and the other set of image data corresponds to a right-eye visual angle. The image corresponding to the left-eye visual angle is referred to as a left-eye visual image, and the image corresponding to the right-eye visual angle is referred to as a right-eye visual image.

The prior art includes three modes of establishing a 3D image. In a first mode, a 3D scene, including virtual characters, virtual objects, virtual buildings, and the like, is established through virtual reality software, and then the 3D scene is shot with a camera kit of the virtual reality software in different visual angles. However, an image produced by the virtual reality software already has depth information (i.e., the image has included 3 axial data perpendicular to one another, and the shot object or scene can be rotated under the control of the virtual reality software).

In a second mode, two camera devices are used to shoot the same scene, so as to generate images of the scene in two visual angles, and the two visual images are respectively a left-eye visual image and a right-eye visual image. When the image is displayed, the left eye of a viewer is made to merely see the left-eye visual image, and the right eye of the viewer is made to merely see the right-eye visual image. Accordingly, a stereoscopic vision is generated in the brain of the viewer, such that the viewer feels that a real 3D object is viewed.

In a third mode, a camera device with an infrared sensor is used to shoot a scene, in which the infrared sensor emits an infrared ray, the infrared ray is reflected when encountering the object under shot, and the infrared sensor receives the reflected infrared ray and determines a distance between the scene and the camera device according to conditions such as time and frequency of receiving the infrared ray, so as to determine the depth change of an outline of the real scene, thereby calculating the depth data of the scene to be integrated in the shot image.

However, the mode of establishing a 3D scene through the virtual reality software before shooting an image needs to firstly design a virtual scene and shoot the virtual scene to produce 3D animations, which is rather time-consuming and cannot be applied to shoot real objects (including characters or articles).

Furthermore, in the mode of shooting the same scene to generate two different images corresponding to different visual angles and combining the two images into a 3D image, although viewers can all have a stereoscopic sensation about the object from the 3D image, DOF data or DOF signals cannot be obtained from the 3D image.

Moreover, when images are shot with the camera device having the infrared sensor, relevant DOF data can be calculated by using the infrared ray to sense the depth and distance from the scene. However, the sensing distance of the infrared sensor is quite limited, and when the camera device is too far away from the real scene, the infrared sensor is unable to sense the depth change of the outline of the real scene, that is, unable to obtain valid DOF data correctly.

Therefore, how to effectively obtain DOF data of a 3D image has become a task for different manufacturers.

### SUMMARY OF THE INVENTION

Accordingly, the present invention is directed to a method and a system capable of obtaining DOF data of a 3D image rapidly and effectively.

To achieve the objective, the present invention provides a method of establishing depth of field (DOF) data of a three-dimensional (3D) image, applicable to a 3D image comprising a first visual image and a second visual image. In the method, an offset vector matrix is established. The offset vector matrix includes a plurality of data fields, and each data filed is corresponding to n first pixels of the first visual image and the n is a natural number. An a^{th} first pixel of the first visual image is obtained and the a is an integer between 1 and n. A reference frame in the first visual image is established according to a pixel selection block by taking the a^{th} first pixel as a center, and the reference frame includes a plurality of first pixels. A target frame in the second visual image is searched for according to the reference frame where the a^{th} first pixel belongs to, wherein the target frame has a minimum grayscale difference value with the reference frame. An offset vector value of the a^{th} first pixel is calculated according to the minimum grayscale difference value. Therefore, the offset vector values corresponding to all of the a^{th} first pixels are found and recorded in the offset vector matrix. The offset vector matrix is converted into a depth map.

To achieve the objective, the present invention provides a system of establishing depth of field (DOF) data of a three-dimensional (3D) image, applicable to a 3D image comprising a first visual image and a second visual image. The system includes a storage module, an offset calculator, and a comparator.

The storage module is used for recording an offset vector matrix. The offset vector matrix includes a plurality of data fields, and the data fields are corresponding to n first pixels of the first visual image and the n is a natural number. The offset calculator is used for establishing a reference frame including a plurality of first pixels in the first visual image according to a pixel selection block by taking an a^{th} first pixel as a center. A target frame image is searched for from the second visual image according to the reference frame where the a^{th} first pixel belongs to, and the target frame has a minimum grayscale difference value with the reference frame. An offset vector value is calculated according to the minimum grayscale difference value. The comparator is used for recording the offset vector value corresponding to each first pixel into the data fields of the offset vector matrix. When it is determined that the offset vector values of the a^{th} first pixels have all been recorded, the comparator converts the offset vector matrix into a depth map.

In the method and the system according to the present invention, the above depth map is generated rapidly when a conventional 3D left-eye visual image and a conventional 3D right-eye visual image are converted into 2D images, such that an image displaying device displays a 3D image having a stereoscopic sensation according to the 2D images and the depth map and displays 3D effects corresponding to a plurality of viewing points of the 3D image. Moreover, an offset vector matrix records offset vector values of all the first pixels in a second visual image, so as to be converted to form the depth map. Thus, when the depth map is combined with the original 3D image, the synthesis effect of the 3D image can be effectively improved. Furthermore, the method and the system according to the present invention not only processes images generated by camera devices, but also processes animation pictures or static pictures that are not obtained through a photographing process, thereby further expanding the application range, applicable situation, and application layer of the present invention.

### BRIEF DESCRIPTION OF THE DRAWINGS

The present invention will become more fully understood from the detailed description given herein below for illustration only, and thus is not limitative of the present invention, and wherein:

FIG. 1 is a block diagram of a system according to an embodiment of the present invention;

FIG. 2 is a flow chart of a method of establishing DOF data according to an embodiment of the present invention;

FIG. 3 is a schematic view of dividing a reference frame according to the present invention;

FIG. 4 is a schematic structural view of a reference frame according to an embodiment of the present invention;

FIG. 5 is a detailed flow chart of a method of establishing DOF data according to the present invention;

FIG. 6 is a configuration diagram of a pre-selection frame in a second visual image according to an embodiment of the present invention;

FIG. 7 is a structural view of a pre-selection frame according to an embodiment of the present invention;

FIG. 8 shows a format code pattern of a pixel selection block according to an embodiment of the present invention;

FIG. 9 is a schematic view of an offset vector matrix according to an embodiment of the present invention;

FIG. 10 shows an offset vector matrix Z according to an embodiment of the present invention;

FIG. 11 shows a method of establishing DOF data of a 3D image according to another embodiment of the present invention;

FIG. 12 shows a first visual image of a shot scene according to an embodiment of the present invention;

FIG. 13 shows a second visual image of the shot scene according to an embodiment of the present invention;

FIG. 14 shows a Z depth map according to an embodiment of the present invention;

FIG. 15 shows a 3D image in a first visual angle from right to left according to the present invention;

FIG. 16 shows the 3D image in a second visual angle from right to left according to the present invention;

FIG. 17 shows the 3D image in a third visual angle from right to left according to the present invention; and

FIG. 18 shows the 3D image in a fourth visual angle from right to left according to the present invention.

### DETAILED DESCRIPTION OF THE INVENTION

In order to make the objects, structural features, and functions of the present invention more comprehensible, the present invention is described below in detail through relevant embodiments and accompanying drawings.

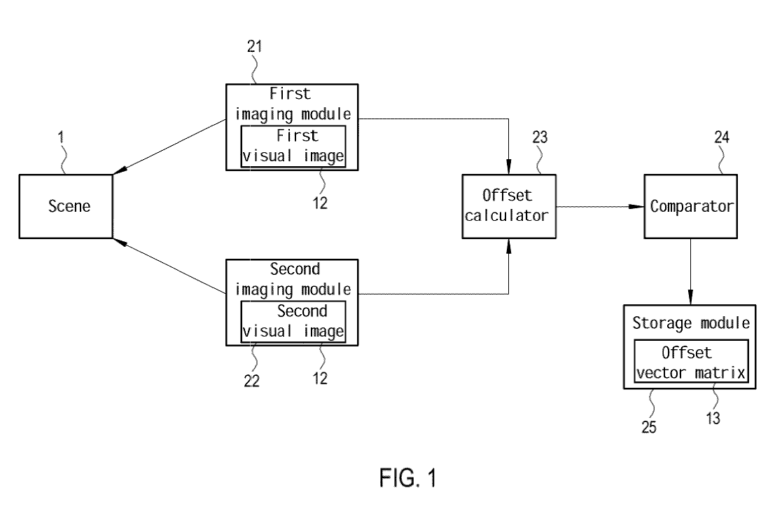

FIG. 1 is a block diagram of a system according to an embodiment of the present invention. Referring to FIG. 1, the system includes a first imaging module 21, a second imaging module 22, a storage module 25, an offset calculator 23, and a comparator 24.

The first imaging module 21 shoots a scene 1 to generate a first visual image 11, and the second imaging module 22 shoots the same scene 1 to generate a second visual image 12. The storage module 25 records an offset vector matrix 13, and the offset vector matrix 13 includes a plurality of data fields. The number of the data fields is the same as that of the first pixels of the first visual image 11 on which an offset calculation is to be performed, which is set as n herein and n is a natural number.

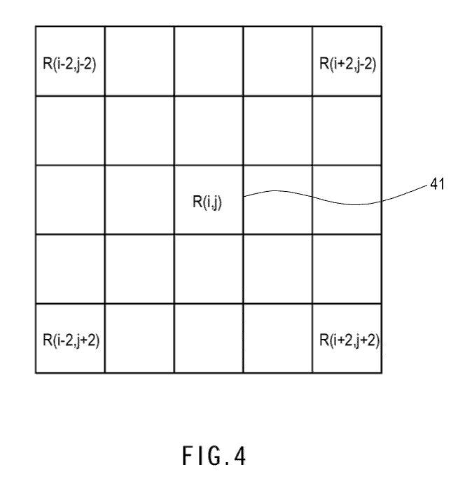

The offset calculator 23 establishes a reference frame 31 in the first visual image 11 according to a pixel selection block by taking an a^{th} first pixel 41 (as shown in FIG. 4) of the first visual image 11 as a center, and the reference frame 31 further includes several other first pixels besides the a^{th} first pixel 41. The offset calculator 23 finds out a target frame from the second visual image 12 according to the reference frame 31 where the a^{th} first pixel 41 belongs to, and a second pixel of the target frame has a minimum grayscale difference value with the first pixel of the reference frame 31, such that an offset vector value of the a^{th} first pixel 41 on the second visual image 12 is calculated through the minimum grayscale difference value.

The comparator 24 is used to record each offset vector value to the data fields of the offset vector matrix 13, that is, the offset vector value of the a^{th} first pixel 41 is recorded in the a^{th} data field. After that, the comparator 24 sets an (a+1)^{th} first pixel as the a^{th} first pixel to return to the offset calculator 23 when it is determined that the data fields of the offset vector matrix 13 are not all filled with values, and then requests the offset calculator 23 to re-calculate and record the related offset vector values; on the contrary, the comparator 24 converts the offset vector matrix 13 into a depth map when it is determined that the offset vector values of the a^{th} first pixels have all been recorded.

It should be noted that, the above pixels may be commonly known pixels or sub-pixels.

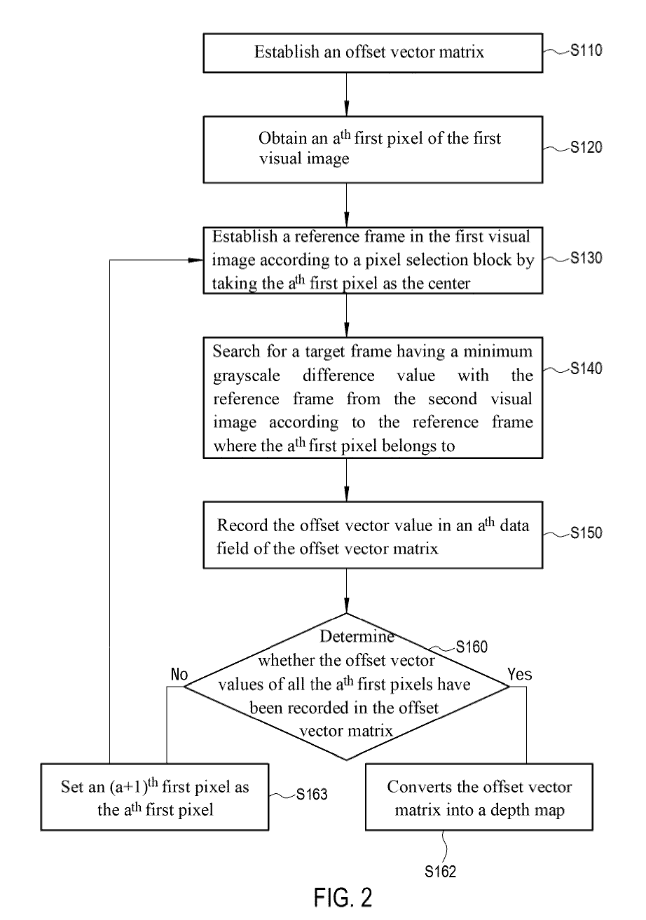

FIG. 2 is a flow chart of a method of establishing DOF data of a 3D image according to an embodiment of the present invention, which may be further understood together with reference to the block diagram of the system shown in FIG. 1. In addition, FIG. 2 shows the operating flow of the system in FIG. 1. Before implementing the method, the first imaging module 21 and the second imaging module 22 are respectively used to shoot a scene 1 to form a 3D image, and the 3D image includes a first visual image 11 and a second visual image 12. It should be noted that, the first visual image 11 is a left-eye visual image and the second visual image 12 is a right-eye visual image; or the first visual image 11 is a right-eye visual image and the second visual image 12 is a left-eye visual image. In this embodiment, the right-eye visual image is considered as the first visual image 11 and the left-eye visual image is considered as the second visual image 12. The method includes the following steps.

An offset vector matrix 13 is established (Step S110). The offset vector matrix 13 includes a plurality of data fields corresponding to n first pixels of the first visual image 11, and n is a natural number. As shown in FIG. 1, a matrix is established in the storage module 25, and the matrix may be a 1D matrix or a 2D matrix, but the number of data fields of the matrix should be higher than or equal to that of the first pixels, on which the offset vector calculation is to be performed, in the first visual image 11. Here, the matrix is considered as the offset vector matrix 13, the number of the data fields is n, and the number of the first pixels of the first visual image 11 on which the offset vector calculation is to be performed is also n.

An a^{th} first pixel 41 of the first visual image 11 is obtained (Step S120), in which a is an integer between 1 and n. In this step, the first pixels of the first visual image 11 are arranged in a sequence from left to right and from top to bottom, so that the top-left first pixel is considered as the 1^{st} first pixel of the first visual image 11, and the bottom-right first pixel is considered as the last first pixel of the first visual image 11.

By taking the a^{th} first pixel 41 as the center, a reference frame 31 is established in the first visual image 11 according to a pixel selection block (Step S130). The reference frame 31 further includes a plurality of first pixels for performing grayscale comparison. The reference frame 31 may be in a square shape having a length of 3 pixel length, 5 pixel length, 7 pixel length, or 9 pixel length, that is, odd-numbered pixel length.

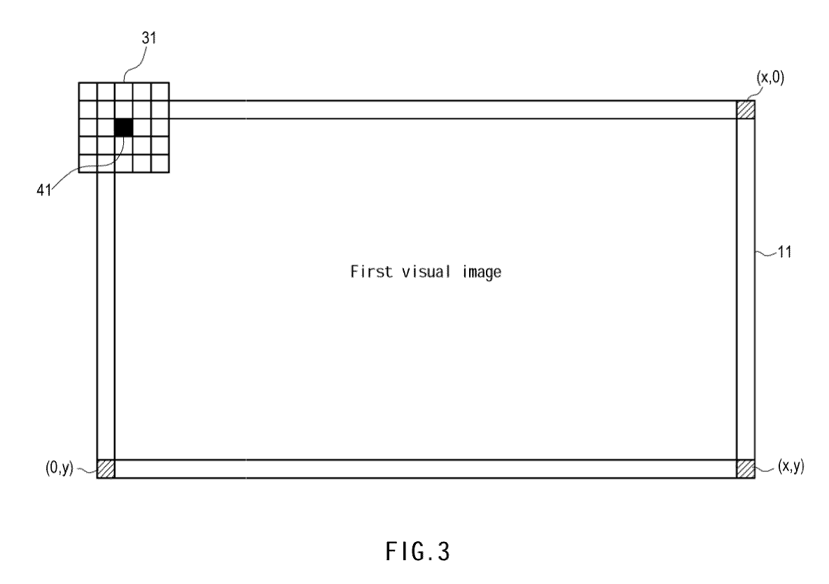

FIG. 3 is a schematic view of dividing the reference frame 31 according to the present invention. Referring to FIG. 3, in this embodiment, for example, the reference frame 31 is a square of 5×5, and the 1^{st} first pixel is taken as the center. However, the reference frame 31 might exceed the boundary of the first visual image 11, and in this case, the values of the first pixels at the boundary of the first visual image 11 may be used to compensate the exceeding range of the reference frame 31. For example, it is assumed that the pixel selection block of the first visual image 11 is (x,y), and if the reference frame 31 exceeds the top boundary of the first visual image 11, the first pixels of (0,0) to (x,0) are used to perform compensation; if the reference frame 31 exceeds the left boundary of the first visual image 11, the first pixels of (0,0) to (0,y) are used to perform compensation; if the reference frame 31 exceeds the bottom boundary of the first visual image 11, the first pixels of (0,y) to (x,y) are used to perform compensation; and if the reference frame 31 exceeds the right boundary of the first visual image 11, the first pixels of (x,0) to (x,y) are used to perform compensation.

FIG. 4 is a schematic structural view of the reference frame 31 according to an embodiment of the present invention. Referring to FIG. 4, the pixel coordinates of the a^{th} first pixel 41 of the first visual image 11 is R(i,j), in which i and j are both natural numbers, and R indicates that the first visual image 11 is the right-eye visual image in this embodiment. Therefore, the pixel coordinates of all the first pixels in the reference frame 31 are in a range from R(i−2,j−2) to R(i+2,j+2), and the first pixels are arranged in a sequence from left to right and from top to bottom. It is assumed that the current a^{th} first pixel is the 1^{st} first pixel with the pixel coordinates of (0, 0), so that the pixel coordinates of all the first pixels in the reference frame 31 are in a range from R(−2,−2) to R(2,2).

A target frame having a minimum grayscale difference value with the reference frame 31 is searched for from the second visual image 12 according to the reference frame 31 where the a^{th} first pixel 41 belongs to (Step S140).

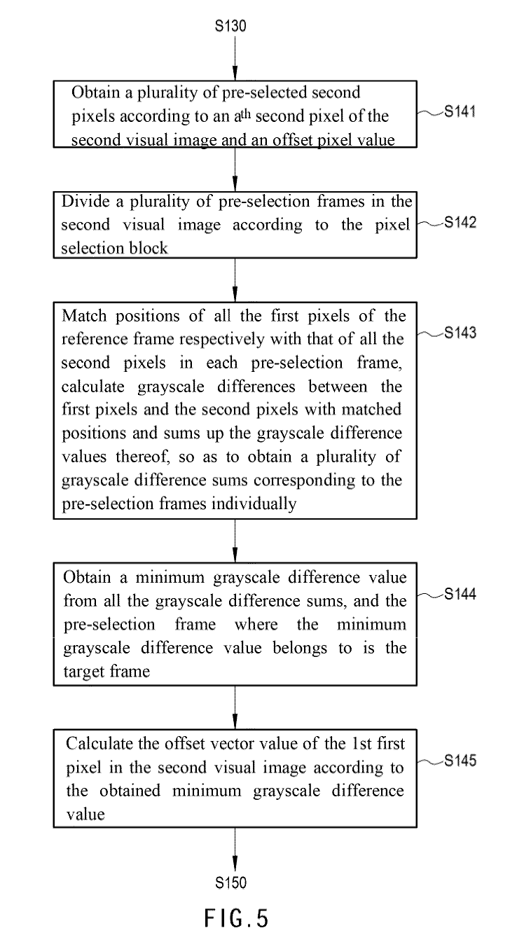

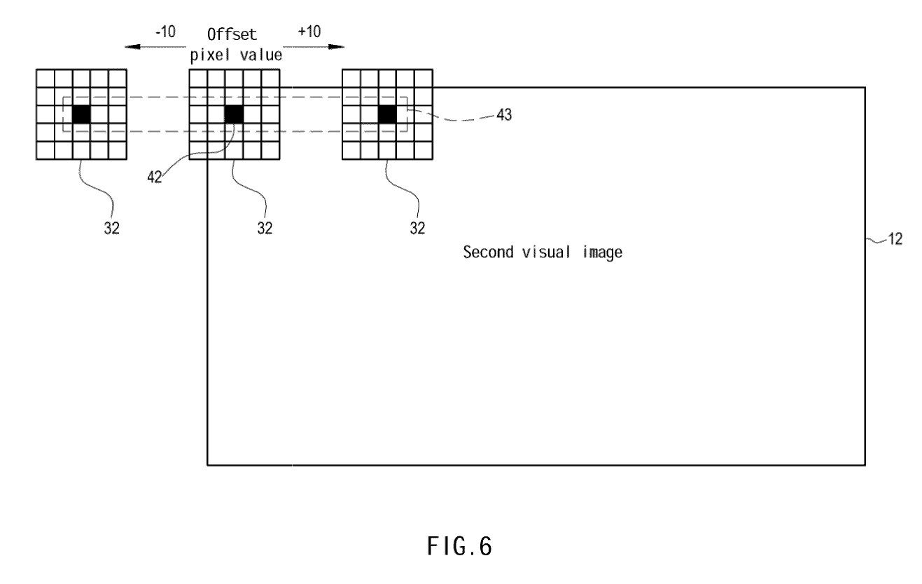

FIG. 5 is a detailed flow chart of a method of establishing DOF data according to the present invention, which may be further understood together with reference to FIG. 6, and FIG. 6 is a configuration diagram of a pre-selection frame 32 in the second visual image 12 according to an embodiment of the present invention. In this step, a plurality of pre-selected second pixels 43 is obtained according to an a^{th} second pixel 42 of the second visual image 12 and an offset pixel value (Step S141). The offset pixel value is set as x, and the selection range of the pre-selected second pixels 43 is from the (a−x)^{th} second pixel to the (a+x)^{th} second pixel, in which x is an integer between 0 and n. It is assumed that the center of the reference frame 31 is the 1^{st} first pixel and the offset pixel value is 10, so that the offset calculator 23 selects the 1^{st} second pixel from the second visual image 12, and considers the (1−10)^{th} second pixel to the (1+10)^{th} second pixel, i.e., the (−9)^{th} second pixel to the 11^{th} second pixel, as the pre-selected second pixels 43.

The offset calculator 23 divides a plurality of pre-selection frames 32 in the second visual image 12 according to the pixel selection block by taking the pre-selected second pixels 43 as centers, and each of the pre-selection frames 32 includes a plurality of second pixels (Step S142).

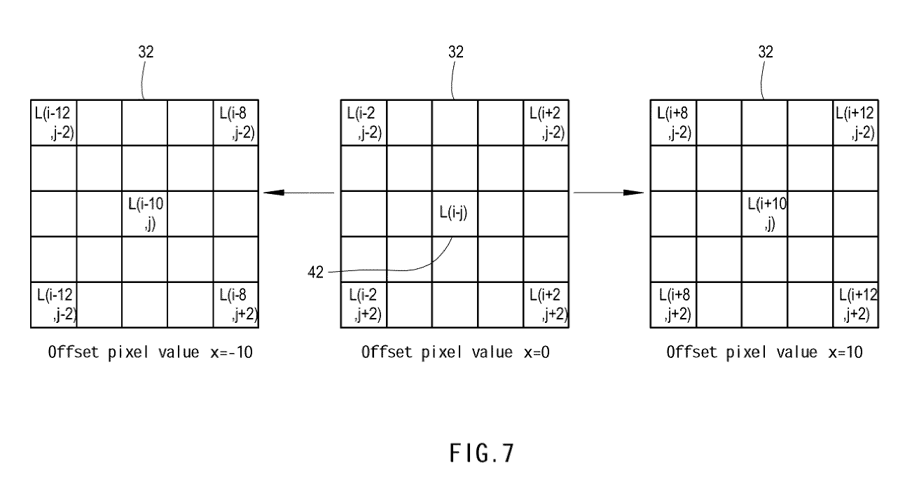

FIG. 7 is a structural view of the pre-selection frame 32 according to an embodiment of the present invention. Referring to FIG. 7, in this embodiment, the structure of each pre-selection frame 32 is similar to that of the reference frame 31 shown in FIG. 4, that is, in a square shape of 5×5. It is assumed that the pixel coordinates of the a^{th} second pixel 42 of the second visual image 12 is L(i, j), in which i and j are both natural numbers, and L indicates that the second visual image 12 is the left-eye visual image in this embodiment.

The pre-selection frame 32 where the a^{th} second pixel 42 belongs to includes second pixels with pixel coordinates in a range from L(i−2,j−2) to L(i+2,j+2), and the second pixels are arranged in a sequence from left to right and from top to bottom. It is assumed that the current a^{th} second pixel is the 1^{st} second pixel with the pixel coordinates of L (0,0), so that the pixel coordinates of the second pixels in the pre-selection frame 32 where the 1^{st} second pixel belongs to is in a range from L(−2,−2) to L(2,2).

Likewise, when the a^{th} second pixel is the 2^{nd} second pixel with the pixel coordinates of L(1,0), the pixel coordinates of all the second pixels included in the pre-selection frame 32 are in a range from L(−1,−2) to L(3,2). When the a^{th} second pixel is the 10^{th} second pixel with the pixel coordinates of L(10,0), the pixel coordinates of all the second pixels included in the pre-selection frame 32 are in a range from L(8,−2) to L(12,2). When the a^{th} second pixel is the (−9)^{th} second pixel with the pixel coordinates of L(−10,0), the pixel coordinates of all the second pixels included in the pre-selection frame 32 are in a range from L(−12,−2) to L(−8,2).

However, any one of the pre-selection frames 32 may exceed the boundary of the second visual image 12, and in this case, the pixel values of the second pixels at the boundary of the second visual image 12 may be used for compensation. For example, the pixel length and the pixel width of the second visual image 12 are set as (p,q), and if the pre-selection frame 32 exceeds the top boundary of the second visual image 12, the second pixels of (0,0) to (p,0) are used to perform the compensation; if the pre-selection frame 32 exceeds the left boundary of the second visual image 12, the second pixels of (0,0) to (0,q) are used to perform the compensation; if the pre-selection frame 32 exceeds the bottom boundary of the second visual image 12, the second pixels of (0,q) to (p,q) are used to perform the compensation; and if the pre-selection frame 32 exceeds the right boundary of the second visual image 12, the second pixels of (p,0) to (p,q) are used to perform the compensation.

The offset calculator 23 matches positions of all the first pixels of the reference frame 31 respectively with that of all the second pixels in each pre-selection frame 32, calculates grayscale differences between the first pixels and the second pixels with matched positions and sums up the grayscale difference values thereof, so as to obtain a plurality of grayscale difference sums corresponding to the pre-selection frames 32 individually (Step S143).

For example, the offset calculator 23 obtains grayscale values corresponding to all the first pixels, i.e., R(−2,−2) to R(2,2), in the reference frame 31 where the 1^{st} first pixel belongs to. The offset calculator 23 selects any pre-selection frame 32 where a pre-selected second pixel 43 belongs to, for example, when the pre-selection frame 32 where the 11^{th} second pixel belongs to (i.e., the offset pixel value x=10) is selected, the offset calculator 23 obtains the grayscale values of all the second pixels in the pre-selection frame 32 where the 11^{th} second pixel belongs to.

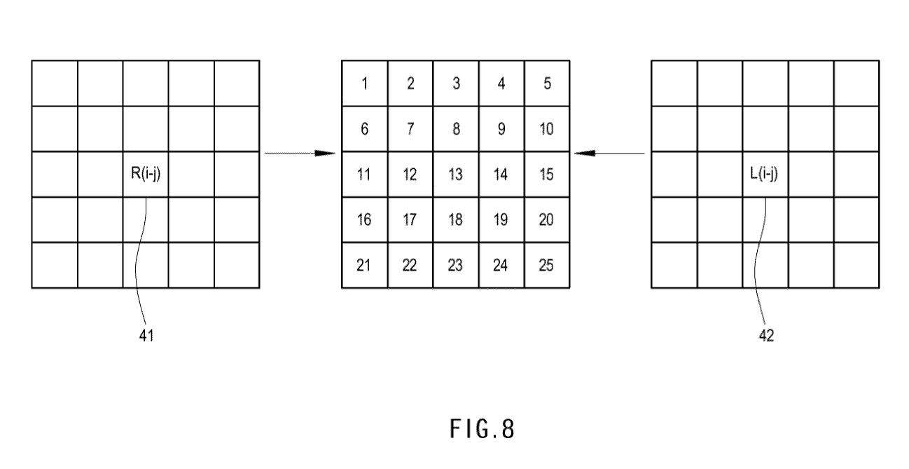

FIG. 8 shows a format code pattern of a pixel selection block according to an embodiment of the present invention. Referring to FIG. 8, as described above, the offset calculator 23 respectively divides the reference frame 31 and the pre-selection frame 32 in the first visual image 11 and the second visual image 12 according to the same pixel selection block. Therefore, according to the format of the pixel selection block, the offset calculator 23 calculates the grayscale differences between the first pixels and the second pixels corresponding to the same format code, that is, having corresponding pixel positions. Then, the offset calculator 23 sums up all the grayscale difference values thereof to form a grayscale difference sum corresponding to the pre-selection frame 32. The calculation equation is listed as follows:

D(x)=[L(i−2+x,j−2)−R(i−2,j−2)]²+[L(i−1+x,j−2)−R(i−1,j−2)]²+K+[L(i+x,j)−R(i,j)]²+A+[L(i+2+x,j+2)−R(i+2,j+2)]²

In this embodiment, the grayscale difference sum of the reference frame 31 of the 1^{st} first pixel and the pre-selection frame 32 of the 11^{th} second pixel is listed as follows:

D(10)=[L(i−2+10,j−2)−R(i−2,j−2)]²+[L(i−1+10,j−2)−R(i−1,j−2)]²+K+[L(i+10,j)−R(i,j)]²+A+[L(i+2+10,j+2)−R(i+2,j+2)]²

Likewise, the grayscale difference sums of the reference frame 31 of the 1^{st} first pixel and the pre-selection frames 32 of the other pre-selected second pixels 43 (i.e., the 10^{th} second pixel to the (−9)^{th} second pixel, having offset pixel values in a range of −10 to 9) are respectively listed as follows:

$$\begin{matrix}D ( 9 ) = {[ L ( i - 2 + 9 , j - 2 ) - R ( i - 2 , j - 2 ) ]}^{2} + \\ {[ L ( i - 1 + 9 , j - 2 ) - R ( i - 1 , j - 2 ) ]}^{2} + K + \\ {[ L ( i + 9 , j ) - R ( i , j ) ]}^{2} + Λ + {[ L ( i + 2 + 9 , j + 2 ) - R ( i + 2 , j + 2 ) ]}^{2} \\ D ( 8 ) = {[ L ( i - 2 + 8 , j - 2 ) - R ( i - 2 , j - 2 ) ]}^{2} + \\ {[ L ( i - 1 + 8 , j - 2 ) - R ( i - 1 , j - 2 ) ]}^{2} + K + \\ {[ L ( i + 8 , j ) - R ( i , j ) ]}^{2} + Λ + {[ L ( i + 2 + 8 , j + 2 ) - R ( i + 2 , j + 2 ) ]}^{2} \\ ⋮ \\ D ( 0 ) = {[ L ( i - 2 , j - 2 ) - R ( i - 2 , j - 2 ) ]}^{2} + \\ {[ L ( i - 1 , j - 2 ) - R ( i - 1 , j - 2 ) ]}^{2} + K + \\ {[ L ( i , j ) - R ( i , j ) ]}^{2} + Λ + {[ L ( i + 2 , j + 2 ) - R ( i + 2 , j + 2 ) ]}^{2} \\ ⋮ \\ D ( - 8 ) = {[ L ( i - 2 - 8 , j - 2 ) - R ( i - 2 , j - 2 ) ]}^{2} + \\ {[ L ( i - 1 - 8 , j - 2 ) - R ( i - 1 , j - 2 ) ]}^{2} + K + \\ {[ L ( i - 8 , j ) - R ( i , j ) ]}^{2} + Λ + {[ L ( i + 2 - 8 , j + 2 ) - R ( i + 2 , j + 2 ) ]}^{2} \\ D ( - 9 ) = {[ L ( i - 2 - 9 , j - 2 ) - R ( i - 2 , j - 2 ) ]}^{2} + \\ {[ L ( i - 1 - 9 , j - 2 ) - R ( i - 1 , j - 2 ) ]}^{2} + K + \\ {[ L ( i - 9 , j ) - R ( i , j ) ]}^{2} + Λ + {[ L ( i + 2 - 9 , j + 2 ) - R ( i + 2 , j + 2 ) ]}^{2} \\ D ( - 10 ) = {[ L ( i - 2 - 10 , j - 2 ) - R ( i - 2 , j - 2 ) ]}^{2} + \\ {[ L ( i - 1 - 10 , j - 2 ) - R ( i - 1 , j - 2 ) ]}^{2} + K + \\ {[ L ( i - 10 , j ) - R ( i , j ) ]}^{2} + Λ + {[ L ( i + 2 - 10 , j + 2 ) - R ( i + 2 , j + 2 ) ]}^{2} .\end{matrix}$$

The offset calculator 23 obtains a minimum grayscale difference value from all the grayscale difference sums, and the pre-selection frame 32 where the minimum grayscale difference value belongs to is the target frame (Step S144).

The offset calculator 23 calculates the offset vector value of the 1^{st} first pixel in the second visual image 12 according to the obtained minimum grayscale difference value (Step S145). In this embodiment, it is assumed that D(−8) is the minimum grayscale difference value, and −8 is the offset vector value of the 1^{st} first pixel in the second visual image 12. That is, the offset vector value is x, and each offset vector value is an integer between −x and x.

The comparator 24 records the offset vector value in an a^{th} data field of the offset vector matrix 13 (Step S150). In this embodiment, the a^{th} first pixel 41 refers to the 1^{st} first pixel, and the obtained offset vector value also refers to the offset value of the 1^{st} first pixel in the second visual image 12, so the comparator 24 records the offset vector value (e.g., −8 as described above) corresponding to the 1^{st} first pixel in the 1^{st} data field of the offset vector matrix 13.

The comparator 24 determines whether the offset vector values of all the a^{th} first pixels 41 have been recorded in the offset vector matrix 13 (Step S160). In this embodiment, the comparator 24 determines whether the a^{th} first pixel 41 currently used to perform the calculation of the offset vector value is the last first pixel of the first visual image 11, i.e., the n^{th} first pixel.

When the comparator 24 determines that the current a^{th} first pixel 41 is not the n^{th} first pixel, the offset vector values of the first pixels in the first visual image 11 are not all recorded. The comparator 24 sets an (a+1)^{th} first pixel as the a^{th} first pixel 41 (Step S163).

In the above embodiment, the a^{th} first pixel 41 is the 1^{st} first pixel, and the (a+1)^{th} first pixel is the 2^{nd} first pixel. After Step S163, the comparator 24 considers the 2^{nd} first pixel as the a^{th} first pixel 41, the 3^{rd} second pixel as the (a+1)^{th} first pixel, the 1^{st} first pixel as the (a−1)^{th} first pixel, and so forth. Thereafter, the comparator 24 performs Step S130 to Step S163 once again until the offset vector values of all the a^{th} first pixels 41 are recorded in the offset vector matrix 13.

When the comparator 24 determines that the a^{th} first pixel 41 is the n^{th} first pixel, it indicates that the offset vector values of the first pixels are all recorded in the offset vector matrix 13. The comparator 24 converts the offset vector matrix 13 into a depth map (Step S162).

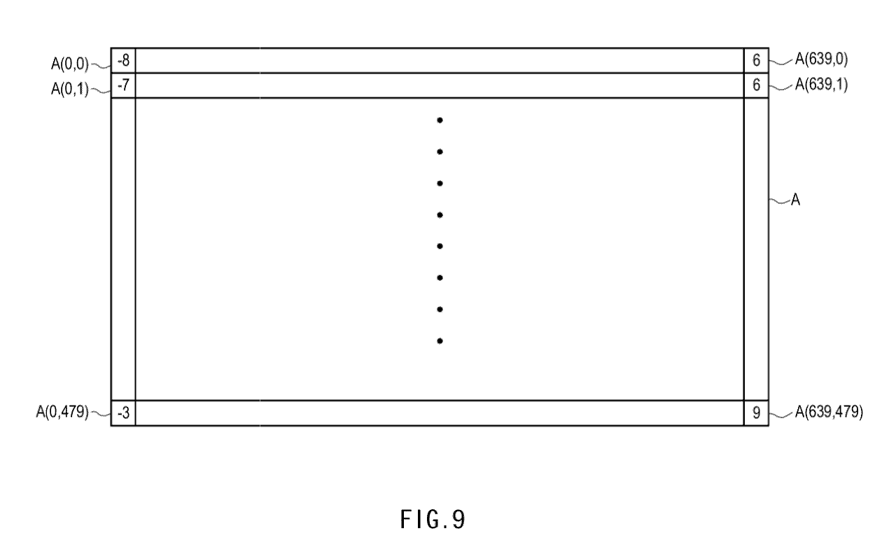

FIG. 9 is a schematic view of the offset vector matrix 13 according to an embodiment of the present invention. Referring to FIG. 9, a configuration of a 2D matrix is taken as an example. The offset vector matrix 13 is set as A, the number of all the data fields is n, which is equal to the number of the first pixels, and a function of each data field is represented by A(i,j). As shown in FIG. 9, the data fields of the offset vector matrix 13 are arranged in the same sequence as the first pixels of the first visual image 11, that is, in a sequence from left to right and from top to bottom. Each data field is corresponding to a first pixel in the first visual image 11, and as described above, the offset vector value of the a^{th} first pixel 41 is recorded in the a^{th} data field. The offset vector value recorded in each data field is between a positive value and a negative value of the offset pixel value, that is, between −x and x. It is assumed that the offset pixel value is between −10 and 10, a resolution of the first visual image 11 is 640×480, that is, totally 307200 first pixels, and the offset vector value of the 1^{st} first pixel is −8, so that the 1^{st} data field is A(0,0)=−8. Similarly, the offset vector value of the (640)^{th} first pixel is 6, so that the 640^{th} data field is A(639,0)=6; the offset vector value of the (641)^{th} first pixel is −7, so that the (641)^{th} data field is A(0,1)=−7, and so forth. The offset vector value of the (307200)^{th} first pixel is 9, so that the (307200)^{th} data field is A(639,479)=9. When all the data fields have recorded the offset vector values of the a^{th} first pixels 41, the offset vector matrix A may be considered as a depth map A. The primary depth map A is used together with the first visual image 11 and the second visual image 12 by an image displaying device to form a 3D image having a depth of field (DOF).

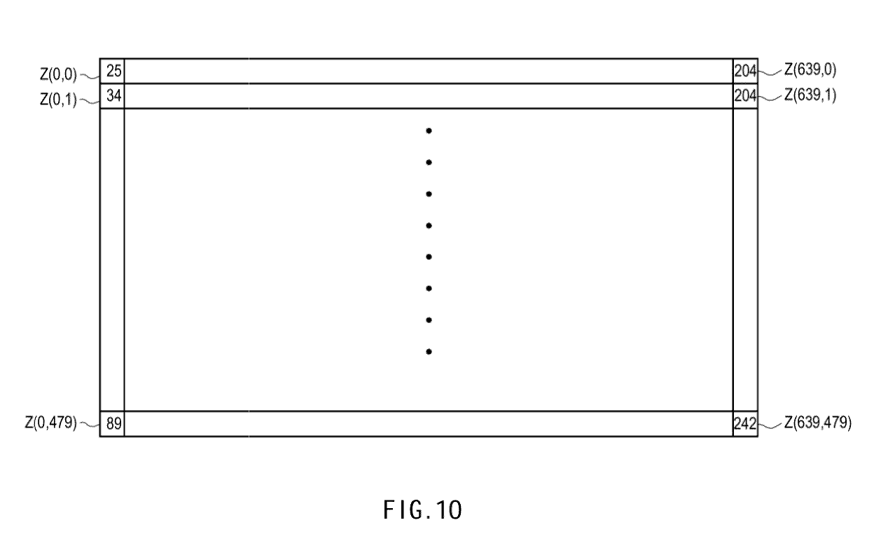

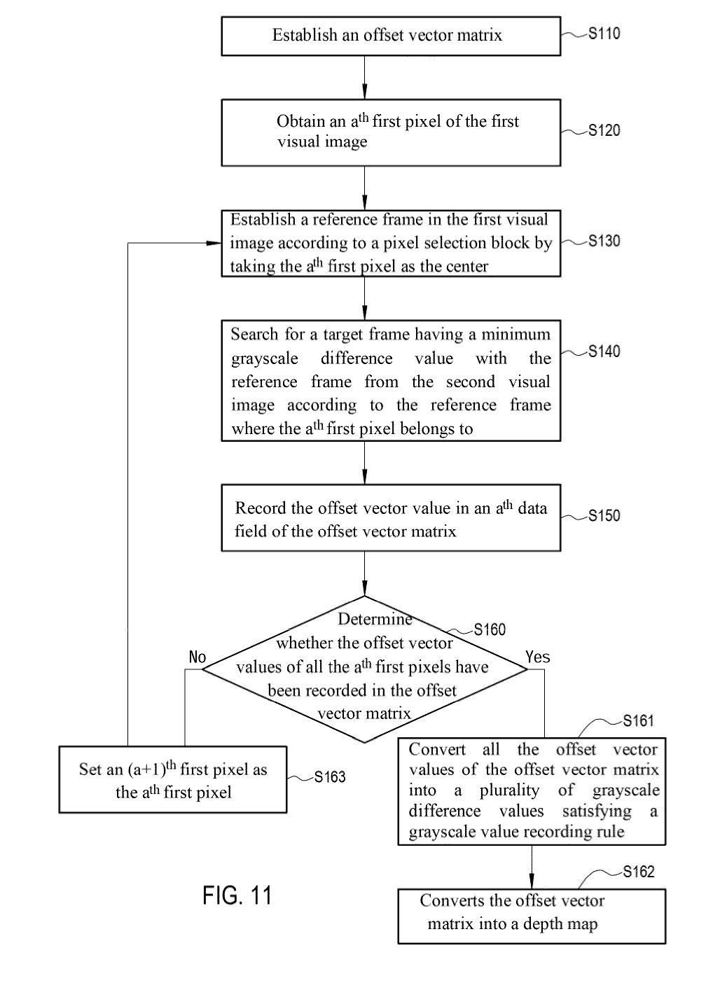

FIG. 10 shows an offset vector matrix Z according to an embodiment of the present invention, which may be further understood together with reference to FIGS. 9 and 11, and FIG. 11 shows a method of establishing DOF data of a 3D image according to another embodiment of the present invention. In order to avoid the circumstance that other manufacturers or image displaying devices do not have the capability of utilizing the depth map A, before the comparator 24 converts the offset vector matrix into a depth map (Step S162), the comparator 24 may be used to convert all the offset vector values of the offset vector matrix 13 into a plurality of grayscale difference values satisfying a grayscale value recording rule (Step S161). The conversion equation is listed as follows:

Z(i,j)=[A(i,j)+x]*(255/2x),

in which x indicates the offset pixel value, and the Z(i, j) indicates the offset vector matrix Z converted from the offset vector matrix A. Each offset vector value is converted into a grayscale difference value satisfying the grayscale value recording rule, and each grayscale difference value is an integer between 0 and 255. Thereafter, the comparator 24 performs Step S162 to convert the offset vector matrix Z into a Z depth map. However, generally speaking, the offset vector matrix Z may be considered as a numeric Z depth map.

As shown in FIG. 10, in the original offset vector matrix A, the 1^{st} data field A(0,0)=−8, the (640)^{th} data field A(639,0)=6, the (641)^{th} data field A(0,1)=−7, and the (307200)^{th} data field A(639,479)=9. When the offset vector matrix A is converted into the offset vector matrix Z, the 1^{st} data field Z(0,0)=25, the (640)^{th} data field Z(639,0)=204, the (641)^{th} data field Z(0,1)=38, and the (307200)^{th} data field A(639,479)=242. The offset vector matrix Z converted from the offset vector matrix A and the Z depth map thereof may be used by other manufacturers or image displaying devices available in the market.

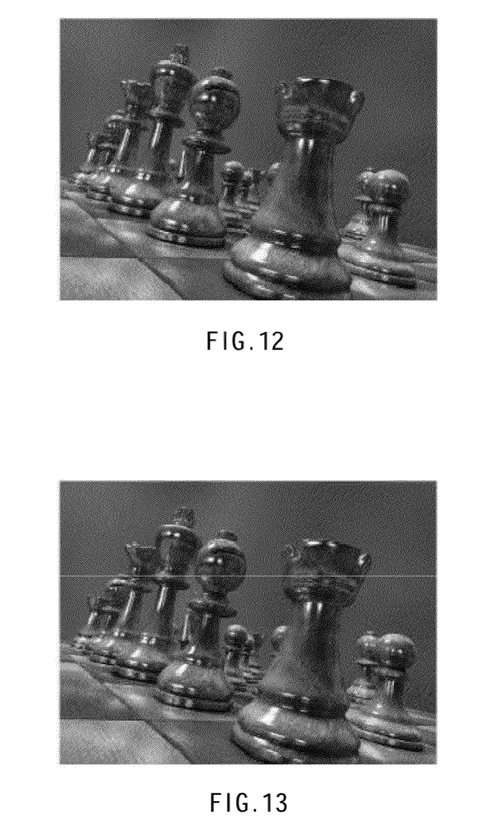

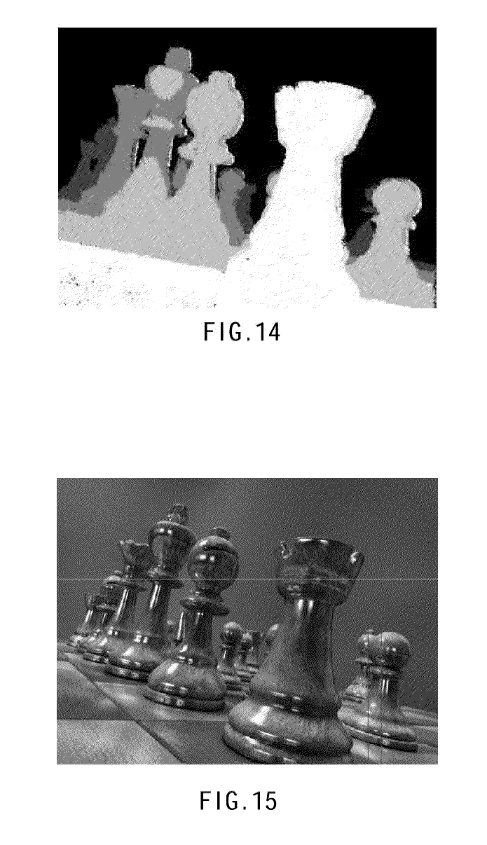

Referring to FIGS. 12, 13, and 14 together, FIG. 12 shows the first visual image 11 of the shot scene 1 according to an embodiment of the present invention, FIG. 13 shows the second visual image 12 of the shot scene 1 according to an embodiment of the present invention, and FIG. 14 shows the Z depth map according to an embodiment of the present invention.

In this embodiment, the first visual image 11 is a right-eye visual image, and the second visual image 12 is a left-eye visual image. According to the above method of establishing DOF data and the system thereof, the offset vector values of all the first pixels of the first visual image 11 in the second visual image 12 may be calculated and then recorded to form the offset vector matrix A. In order to become available for other manufacturers or image displaying devices, the offset vector matrix A is converted into the offset vector matrix Z satisfying the grayscale format, and then, the offset vector matrix Z is converted into the Z depth map as shown in FIG. 13. Thereafter, other manufacturers or image displaying devices may display a 3D image having DOF according to the first visual image 11 and the second visual image 12 in combination with the Z depth map.

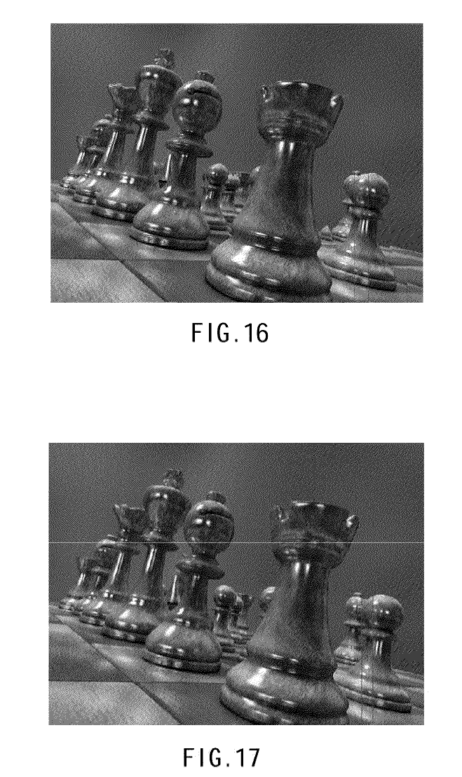

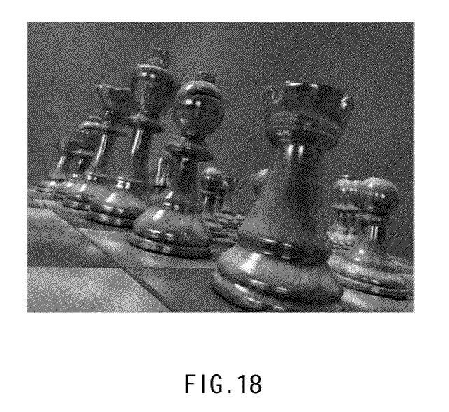

Referring to FIGS. 15, 16, 17, and 18 in sequence, FIG. 15 shows a 3D image in a first visual angle from right to left according to the present invention, FIG. 16 shows the 3D image in a second visual angle from right to left according to the present invention, FIG. 17 shows the 3D image in a third visual angle from right to left according to the present invention, and FIG. 18 shows the 3D image in a fourth visual angle from right to left according to the present invention.

As shown in FIG. 15 to FIG. 18, with reference to the contents in frames of the four drawings, when a viewer views the 3D image from different visual angles, the viewer may distinctly figure out circumstances of different pixel offsets, thus indeed viewing the 3D effects of the 3D image presented at different viewing points.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of establishing depth of field (DOF) data of a three-dimensional (3D) image, applicable to a 3D image comprising a first visual image and a second visual image, the method comprising:
establishing an offset vector matrix, wherein the offset vector matrix comprises a plurality of data fields corresponding to n first pixels of the first visual image, and the n is a natural number;
obtaining an a^{th} first pixel of the first visual image, wherein the a is an integer between 1 and n;
establishing a reference frame in the first visual image according to a pixel selection block by taking the a^{th} first pixel as a center, wherein the reference frame comprises a plurality of first pixels;
searching for a target frame in the second visual image according to the reference frame where the a^{th} first pixel belongs to, wherein the target frame has a minimum grayscale difference value with the reference frame;
calculating an offset vector value of the a^{th} first pixel according to the minimum grayscale difference value;
recording the offset vector value into an a^{th} data field of the offset vector matrix;
determining whether each offset vector value of the a^{th} first pixels have all been recorded;
when it is determined that the offset vector values of the a^{th} first pixels have all been recorded, converting the offset vector matrix into a depth map; and
when it is determined that the offset vector values of the a^{th} first pixels are not all recorded, setting an (a+1)^{th} first pixel as the a^{th} first pixel, and returning to the step of establishing a reference frame in the first visual image according to a pixel selection block.

2. The method of establishing DOF data of a 3D image according to claim 1, wherein the first visual image is a left-eye visual image, and the second visual image is a right-eye visual image.

3. The method of establishing DOF data of a 3D image according to claim 1, wherein the first visual image is a right-eye visual image, and the second visual image is a left-eye visual image.

4. The method of establishing DOF data of a 3D image according to claim 1, wherein the step of searching for a target frame in the second visual image according to the reference frame where the a^{th} first pixel belongs to further comprises:
obtaining a plurality of pre-selected second pixels according to an a^{th} second pixel of the second visual image and an offset pixel value;
establishing a plurality of pre-selection frames in the second visual image according to the pixel selection block by taking the pre-selected second pixels as centers, wherein each of the pre-selection frames comprises a plurality of second pixels;
matching positions of the first pixels of the reference frame individually with positions of the second pixels of each of the pre-selection frames, calculating grayscale differences of the first pixels and the second pixels that have matched positions and summing up the grayscale difference values, and obtaining a plurality of grayscale difference sums corresponding to the pre-selection frames;
obtaining a minimum grayscale difference value from the grayscale difference sums, wherein the pre-selection frame where the minimum grayscale difference value belongs to is the target frame; and
calculating the offset vector value according to the minimum grayscale difference value.

5. The method of establishing DOF data of a 3D image according to claim 4, wherein the offset pixel value is x, the pre-selected second pixels comprises an (a−x)^{th} second pixel to an (a+x)^{th} second pixel, and the x is an integer between 0 and n.

6. The method of establishing DOF data of a 3D image according to claim 5, wherein each offset vector value is an integer between −x and x.

7. The method of establishing DOF data of a 3D image according to claim 1, wherein the pixel selection block is in a square shape, and a length of the square is 3 pixels, 5 pixels, 7 pixels, or 9 pixels.

8. The method of establishing DOF data of a 3D image according to claim 1, wherein before the step of converting the offset vector matrix into a depth map, the method further comprises:
converting the offset vector values of the offset vector matrix into a plurality of grayscale difference values satisfying a grayscale format.

9. The method of establishing DOF data of a 3D image according to claim 8, wherein each of the grayscale difference values is an integer between 0 and 255.

10. A system of establishing depth of field (DOF) data of a three-dimensional (3D) image, applicable to a 3D image comprising a first visual image and a second visual image, the system comprising:
a storage module, for recording an offset vector matrix, wherein the offset vector matrix comprises a plurality of data fields corresponding to n first pixels of the first visual image, and the n is a natural number;
an offset calculator, for establishing a reference frame comprising a plurality of first pixels in the first visual image according to a pixel selection block by taking an a^{th} first pixel as a center, searching for a target frame having a minimum grayscale difference value with the reference frame from the second visual image according to the reference frame where the a^{th} first pixel belongs to, and calculating an offset vector value of the a^{th} first pixel according to the minimum grayscale difference value; and
a comparator, for recording the offset vector value into an a^{th} data field of the offset vector matrix, setting an (a+1)^{th} first pixel as the a^{th} first pixel to return to the offset calculator when it is determined that the data fields of the offset vector matrix are not all filled with values, and converting the offset vector matrix into a depth map when it is determined that the offset vector values of the a^{th} first pixels have all been recorded.

11. The system of establishing DOF data of a 3D image according to claim 10, wherein the first visual image is a left-eye visual image, and the second visual image is a right-eye visual image.

12. The system of establishing DOF data of a 3D image according to claim 10, wherein the first visual image is a right-eye visual image, and the second visual image is a left-eye visual image.

13. The system of establishing DOF data of a 3D image according to claim 10, wherein the comparator searches for the target frame through following steps:
obtaining a plurality of pre-selected second pixels according to an a^{th} second pixel of the second visual image and an offset pixel value;
establishing a plurality of pre-selection frames in the second visual image according to the pixel selection block by taking the pre-selected second pixels as centers, wherein each of the pre-selection frames comprises a plurality of second pixels;
matching positions of the first pixels of the reference frame individually with positions of the second pixels of each of the pre-selection frames, calculating grayscale differences of the first pixels and the second pixels that have matched positions and summing up the grayscale difference values, and obtaining a plurality of grayscale difference sums corresponding to the pre-selection frames;
obtaining a minimum grayscale difference value from the grayscale difference sums, wherein the pre-selection frame where the minimum grayscale difference value belongs to is the target frame; and
calculating the offset vector value according to the minimum grayscale difference value.

14. The system of establishing DOF data of a 3D image according to claim 13, wherein the offset pixel value is x, the pre-selected second pixels comprise an (a−x)^{th} second pixel to an (a+x)^{th} second pixel, and the x is an integer between 0 and n.

15. The system of establishing DOF data of a 3D image according to claim 14, wherein each offset vector value is an integer between −x and x.

16. The system of establishing DOF data of a 3D image according to claim 10, wherein a pixel length and a pixel width of the pixel selection block are 3 pixels, 5 pixels, 7 pixels, or 9 pixels.

17. The system of establishing DOF data of a 3D image according to claim 10, wherein before the comparator converts the offset vector matrix into a depth map, the comparator further converts the offset vector values of the offset vector matrix into a plurality of grayscale difference values satisfying a grayscale value recording rule.

18. The system of establishing DOF data of a 3D image according to claim 17, wherein each of the grayscale difference values is an integer between 0 and 255.
